(19) United States
(12) Patent Application Publication
(10) Pub. No.: US 2026/0256653 A1
(43) Pub. Date: Sep. 3, 2026

(54) TABLET DIVIDING APPARATUS, TABLET PACKING MACHINE, AND TABLET DIVIDING METHOD

(71) Applicant: TOSHO INC., Tokyo (JP)

(72) Inventors: Yoshihito OMURA, Tokyo (JP); Shunji OHGAYA, Tokyo (JP)

(73) Assignee: TOSHO INC., Tokyo (JP)

(21) Appl. No.: 18/866,733

(22) PCT Filed: May 18, 2023
(86) PCT No.: PCT/JP2023/018635

§ 371 Date: Nov. 18, 2024

(30) Foreign Application Priority Data
May 19, 2022 (JP) 2022-082196

(51) Int. Cl. A61J 7/00

(52) U.S. Cl. CPC A61J 7/0007

(57) ABSTRACT

To enable a tablet dividing apparatus to handle tablets having various shapes by performing, with a simple configuration, alignment of the center position of a tablet and a cutting part. A tablet dividing apparatus of the present invention includes a retention part that is disposed midway along a falling path of a tablet and that is for retaining the tablet at a designated position, a cutting part equipped with a blade that is capable of cutting the tablet and that moves to and retreats from the falling path, and center-position determination means for aligning the center position of the tablet with an entry position of the cutting part. The retention part includes a first movable member that is located above the entry position, that forms a lateral surface of the falling path, and that is capable of moving in a direction perpendicular to the falling path and a second movable member that is positioned below the entry position in such a manner as to narrow the falling path and that is capable of moving in a direction parallel to, but opposite to, the first movable member. The center-position determination means determines that the center position of the tablet is aligned with the designated position on the condition that the first movable member and the second movable member are aligned with each other in their respective moving directions.

### TECHNICAL FIELD

The present invention relates to a tablet dividing apparatus that divides a tablet into some tablet cut pieces by cutting the tablet using a cutting part thereof, a tablet packing machine including the tablet dividing apparatus, and a tablet dividing method.

### BACKGROUND ART

In a tablet packing machine that individually packages tablets by dividing them into packets, tablets are often packed after being divided into half or a plurality of pieces for the purpose of dose adjustment or the like.

As a tablet dividing apparatus that divides a tablet into two pieces, a tablet dividing machine that cuts each tablet received one at a time by pushing down a cutter to the tablet has been put to practical use, and in addition, a configuration in which, in order to enable tablets that are retained and accommodated in units of one tablet to be automatically supplied in units of less than one tablet to a subsequent packaging device or the like, cutter blades cut each tablet in a tablet passage path into front and rear pieces in a direction in which the tablet passes through the tablet passage path in such a manner that the cutter blades block the tablet passage path and then the tablet cut pieces are individually discharged (see, for example, PTL 1) and a configuration in which a received tablet is cut into upper and lower pieces by a blade of a cutter and in which the lower tablet cut piece is discharged first while the upper tablet cut piece is temporarily retained on the cutter blades and the upper tablet cut piece is discharged afterward by a subsequent operation of the cutter (see, for example, PTL 2) have been put to practical use.

There is a need for such a tablet dividing apparatus to be capable of dividing each tablet into equal pieces. For example, when a circular tablet is divided into two pieces, a method may be considered in which a tablet is received by a retaining mechanism that has a V-shape and cut into two halves by a cutter that is moved so as to pass through the center of the tablet.

In addition, for example, a method may be considered in which the size of a tablet is specified beforehand with a database or the like or measured and in which a tablet having a known shape and a known size is fixed at a predetermined position and cut (see, for example, PTL 3).

### CITATION LIST

### Patent Literature

PTL 1: Japanese Patent No. 5627508

PTL 2: Japanese Unexamined Patent Application Publication No. 11-226089

PTL 3: Japanese Unexamined Patent Application Publication No. 2021-178168

### SUMMARY OF INVENTION

### Technical Problem

However, such tablet dividing apparatuses of the related art are basically useful only for tablets having normal shapes, such as circular tablets, and it cannot be said that such tablet dividing apparatuses can handle tablets having various shapes, such as oval tablets and diamond-shaped tablets. In addition, in a method of measuring the length of a tablet, it is necessary to measure the size of the tablet beforehand, and it is also known that, if a tablet in a state of the measured shape does not fall or is not conveyed, it is difficult to halve the tablet. In particular, in the case of an oval shape, the curvature and length of an arc portion vary for each tablet, and this requires consideration of multiple patterns, resulting in significant challenges in achieving accurate centering.

The present invention has been made to solve such technical problems, and it is an object of the present invention to provide a tablet dividing apparatus capable of handling various shapes by performing, with a simple configuration, alignment of the center of a tablet and a cutting part.

### Solution to Problem

A tablet dividing apparatus according to the present invention includes a retention part disposed midway along a falling path of a tablet for retaining the tablet at a designated position, a cutting part that includes a blade capable of cutting the tablet by moving into and out of the falling path, and center-position determination means for aligning a center position of the tablet with an entry position of the cutting part. The retention part includes a first movable member that is located above the entry position, that forms a lateral surface of the falling path, and that is capable of moving in a direction perpendicular to the falling path and a second movable member that is positioned below the entry position in such a manner as to narrow the falling path and that is capable of moving in a direction parallel to, but opposite to, the first movable member. The center-position determination means determines that the center position of the tablet is aligned with the designated position on a condition that the first movable member and the second movable member are aligned with each other in a moving direction of the first movable member and a moving direction of the second movable member.

Advantageous Effects of Invention According to such a tablet dividing apparatus, movements of the first movable member and the second movable member enable alignment of the center position of a tablet with the designated position where the cutting part enters even if the tablet has an oval shape or a diamond shape, with which it has been difficult in the related art to perform such alignment. Therefore, the tablet dividing apparatus can handle various shapes.

### BRIEF DESCRIPTION OF DRAWINGS

FIG. 1 is a perspective view illustrating a structure of a tablet dividing apparatus as an example of an embodiment of the present invention.

FIG. 2 is a diagram illustrating an internal structure of the tablet dividing apparatus illustrated in FIG. 1.

FIG. 3 is a perspective view illustrating a principal portion of a retaining mechanism illustrated in FIG. 1, the principal portion being configured to retain a tablet.

FIG. 4 is a diagram illustrating an example of the configuration of the retaining mechanism illustrated in FIG. 3.

FIG. 5 is a diagram illustrating an example of an initial state in an operation of the retaining mechanism illustrated in FIG. 3.

FIG. 6 is a diagram illustrating an example of a reference state in the operation of the retaining mechanism illustrated in FIG. 3.

FIG. 7A is a diagram illustrating an example of tablet-halving means in a configuration of the related art.

FIG. 7B is a diagram illustrating another example of the tablet-halving means in the configuration of the related art.

FIG. 8 is a diagram illustrating an example of a centering operation that is one of the operations of the retaining mechanism illustrated in FIG. 3.

FIG. 9 is a diagram illustrating an example of a state of the retaining mechanism when the centering operation is complete.

FIG. 10 is a diagram illustrating an example of an operation for controlling the retaining mechanism performed by a control device.

FIG. 11 is a diagram illustrating, as a second embodiment of the present invention, an example of a configuration in which a packaging device is added to the tablet dividing apparatus.

FIG. 12 is a diagram illustrating an example of a configuration of a third embodiment of the present invention.

FIG. 13 is a diagram illustrating an example of a state after the centering operation has been performed with the configuration illustrated in FIG. 12.

FIG. 14A is a diagram illustrating a modification of the present invention.

FIG. 14B is a diagram illustrating another modification of the present invention.

### DESCRIPTION OF EMBODIMENTS

Specific embodiments that are examples of a tablet dividing apparatus of the present invention will be described with reference to the drawings.

For simplification, only components that are necessary for the following description of the invention are mainly illustrated in the drawings, and details of fasteners such as bolts, driving sources such as electric motors, transmission members such as gears, electrical circuits such as motor drivers, electronic circuits such as controllers, and the like are not illustrated.

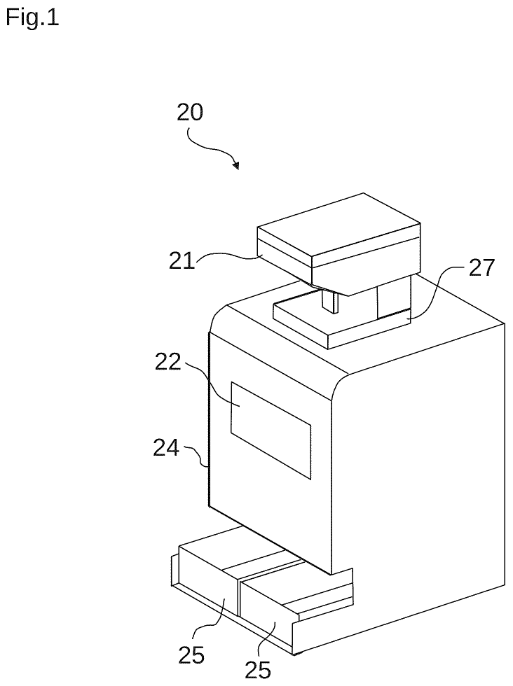

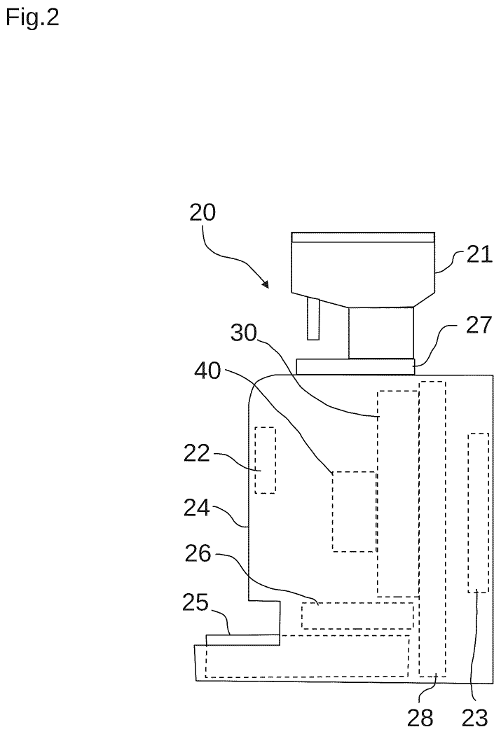

FIG. 1 is an external perspective view of a tablet dividing apparatus 20 of the present invention, and FIG. 2 is a side view of the tablet dividing apparatus 20.

As illustrated in FIG. 1, the tablet dividing apparatus 20 includes, as its basic parts solely in charge of a tablet dividing function, a tablet cassette 21, an operating portion 22, a control unit 23, a main body 24, receivers 25, a relay portion 26, a tablet feeder base portion 27, a support member 28, a retaining mechanism 30, a cutting part 40, and a power supply unit (not illustrated).

The control unit 23, the relay portion 26, the support member 28, the retaining mechanism 30, the cutting part 40, and the power supply unit are accommodated in a housing of the main body 24, and the operating portion 22 and the tablet feeder base portion 27 are fixedly mounted on the main body 24, and an operation surface and a cassette mounting surface are each exposed at an outer surface of the housing.

The tablet cassette 21 is detachably attached to the tablet feeder base portion 27, and each of the receivers 25 is inserted into a front opening of a bottom portion of the main body 24 such that each of the receivers 25 can be drawn out therefrom.

As illustrated in FIG. 1 or FIG. 2, the main body 24 includes the tablet feeder base portion 27 that is fixedly disposed on an uppermost portion thereof, the support member 28 that is disposed in the housing so as to be fixed, in an upright position, to a center portion of the housing in a front-rear direction, and the relay portion 26 that is fixed at a position in front of a lower portion of the support member 28 in the housing. The receivers 25 are arranged below the relay portion 26 such that they can be inserted into and removed from the housing.

In the housing of the main body 24, the retaining mechanism 30 and the cutting part 40 are each attached to the support member 28 or another support member at the center portion. The retaining mechanism 30 is in an upright position like the support member 28, and the cutting part 40 is in a horizontal position so as to be perpendicular to the retaining mechanism 30.

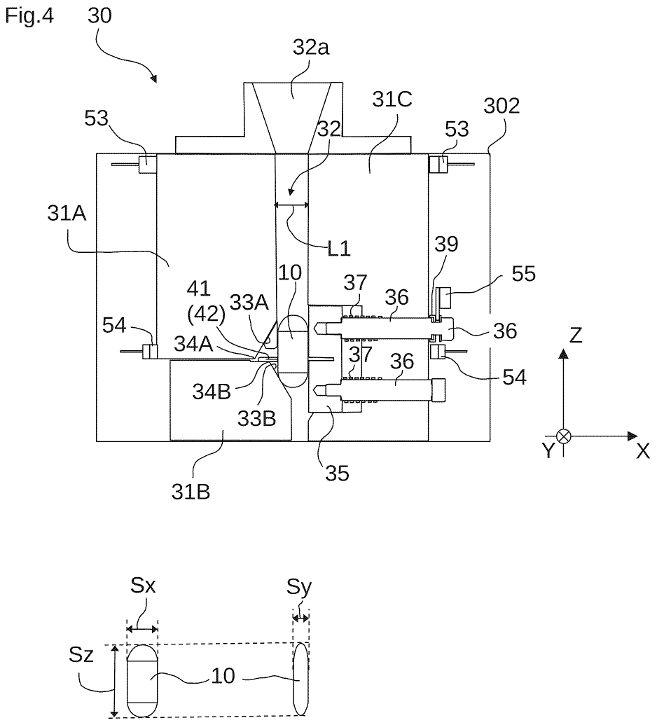

In the present embodiment, the cutting part 40 is cutting means that includes cutting blades 41 each of which is cutting means. The cutting blades 41 are capable of clamping each tablet 10 from front and rear directions of a tablet falling path 32 and then cutting the tablet 10. In the present embodiment, the cutting part 40 is configured to cut each tablet 10 from both sides of the tablet falling path 32 in a top-bottom direction, that is, by entering in ±Y directions that are illustrated in FIG. 4 and that will be mentioned later. However, the cutting part 40 is not limited to having this configuration. The cutting part 40 also includes driving means that is caused by the control unit 23 to drive the cutting blades 41.

In the present embodiment, the cutting blades 41 extend in the X direction illustrated in FIG. 4 and enter gap portions 42 in such a manner as to extend across the tablet falling path 32. The gap portions 42 are openings that are opened at intermediate portions of the tablet falling path 32 and located at entry positions of the cutting blades 41.

The tablet feeder base portion 27 and the tablet cassette 21, which is mounted on the tablet feeder base portion 27, are configured to automatically and successively supply the tablets 10 one at a time. When a drive motor of the tablet feeder base portion 27 operates under control of the control unit 23, the tablets 10 are discharged one at a time from the tablet cassette 21 mounted on the tablet feeder base portion 27, and each tablet 10 is sent from an upper end to an upstream-portion path 32a of the tablet falling path 32 (described later) of the retaining mechanism 30 via a guide, such as an introduction port or a duct.

In the present embodiment, the control unit 23 is control means for controlling each unit of the tablet dividing apparatus 20 and is a controller that instructs sensors, motors, and the like by using electrical signals.

When, for example, the retaining mechanism 30 performs a centering operation, the control unit 23 operates as center-position determination means for aligning the center position of one of the tablets 10 with the positions of the gap portions 42 by exchanging signals with various sensors.

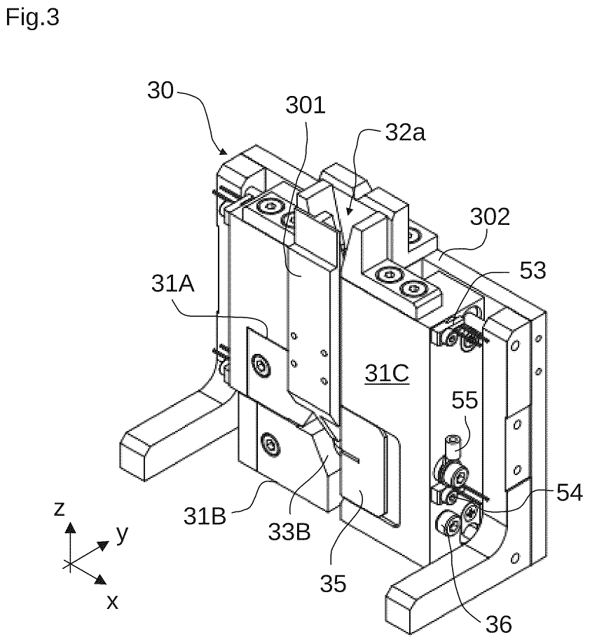

The retaining mechanism 30 is a retention part that uses a first locator 31A, a second locator 31B, and a third locator 31C for retaining, at a designated position, one of the tablets 10 that is to be divided and that has fallen from the tablet cassette 21 and entered the upstream-portion path 32a of the tablet falling path 32 via the tablet feeder base portion 27 and the guide. The first locator 31A is a first movable member and is movable in the X direction in FIG. 3. The second locator 31B is a second movable member disposed below the first locator 31A and is movable in the X direction. The third locator 31C is a third movable member disposed so as to face the first locator 31A and the second locator 31B with the tablet falling path 32 interposed between the third locator 31C and the first and second locators 31A and 31B. As is clear from FIG. 1, the retaining mechanism 3 is disposed midway along a falling path of a tablet that is discharged from the tablet cassette 21.

As illustrated in FIG. 3 and FIG. 4, the first locator 31A includes a rear-end inclined portion 33A that is provided above the entry positions of the cutting blades 41 of the cutting part 40, that is, at a lower right corner portion in FIG. 4, or between a lateral surface facing the tablet falling path 32 and a lateral surface facing the second locator 31B. The rear-end inclined portion 33A is an inclined surface extending at a predetermined inclination angle from the lateral surface of the first locator 31A facing the tablet falling path 32.

An inflection point 34A between the rear-end inclined portion 33A and a lower-side lateral surface of the first locator 31A is located at the lowermost end of the rear-end inclined portion 33A and used as a reference point in the centering operation, which will be described later.

In the tablet falling path 32, the gap portions 42 are provided at positions corresponding to the entry positions of the cutting blades 41 such that each of the cutting blades 41 can pass therethrough in the Y direction.

The retaining mechanism 30 includes a pair of upstream fall sensors 53 that are arranged between the upstream-portion path 32a and the tablet falling path 32 and a pair of downstream fall sensors 54 that are arranged immediately above the gap portions 42, that is, between the entry positions of the cutting blades 41 and the first locator 31A. The upstream fall sensors 53 determine whether each of the tablets 10 has passed therebetween. The downstream fall sensors 54 determine whether each of the tablets 10 has reached the positions of the gap portions 42.

The pair of upstream fall sensors 53 are arranged so as to sandwich the tablet falling path 32, and similarly, the pair of downstream fall sensors 54 are arranged so as to sandwich the tablet falling path 32. The upstream fall sensors 53 and the downstream fall sensors 54 are sensors that transmit signals to the control unit 23 in response to detecting passage of one of the tablets 10. The upstream fall sensors 53 and the downstream fall sensors 54 may each be, for example, an infrared sensor or the like.

A portion of the tablet falling path 32 is formed between the first locator 31A and the third locator 31C, and a lateral surface of the first locator 31A on the +X side and a lateral surface of the third locator 31C on the −X side form lateral surfaces of the tablet falling path 32.

In addition, an upper surface and a lower surface of the tablet falling path 32 are respectively constituted by a ceiling member 301 disposed on the front side and a base member 302 disposed on the rear side. A distance H between the ceiling member 301 and the base member 302 can be variably set in accordance with the height of each tablet 10. Note that a width Sx, a height Sy, and a length Sz of each of the tablets 10 respectively correspond to the X direction, the Y direction, and the Z direction as illustrated in the drawings. However, the present invention is not limited to this configuration, and a guide of the tablet cassette 21 or the upstream-portion path 32a may control falling of each of the tablets 10 in accordance with the shape of the tablet 10 such that the tablet 10 falls in an appropriate orientation.

As illustrated in FIG. 3 and FIG. 4, the second locator 31B includes a front-end inclined portion 33B that is provided below the entry positions of the cutting blades 41, that is, at an upper right corner portion in FIG. 4, or between a lateral surface facing the tablet falling path 32 and a lateral surface facing the first locator 31A. The front-end inclined portion 33B is an inclined surface extending at a predetermined inclination angle from the lateral surface of the second locator 31B facing the tablet falling path 32 and is provided such that the inclination angle of the front-end inclined portion 33B is the same as the inclination angle of the rear-end inclined portion 33A, that is, the front-end inclined portion 33B is provided at an angle at which the front-end inclined portion 33B is line symmetric to the first locator 31A with respect to the gap portions 42.

An inflection point 34B between the front-end inclined portion 33B and an upper-side lateral surface of the second locator 31B is located at the uppermost end of the front-end inclined portion 33B and used as a reference point in the centering operation, which will be described later.

In a basic state until one of the tablets 10 is sent to the upstream-portion path 32a of the tablet falling path 32, the second locator 31B is disposed so as to narrow the tablet falling path 32 as illustrated in FIG. 4. In other words, the second locator 31B is retained in a state of protruding in the +X direction more than the first locator 31A.

The third locator 31C includes a pusher 35, struts 36, springs 37, a contact ring 38, and a terminal 55. The pusher 35 is a pushing unit that pushes each of the tablets 10 against the first locator 31A and the second locator 31B. The struts 36 are support members that support the pusher 35 such that the pusher 35 is movable in the ±X directions and is not movable in either the Z direction or the Y direction. Each of the springs 37 is attached to a corresponding one of the struts 36 and biases the pusher 35. The contact ring 38 is attached to one of the struts 36 on the side opposite to the pusher 35 and serves as sensing means for detecting movement of the pusher 35. The terminal 55 is electrically connected to the contact ring 38 and exchanges signals with the control unit 23. Note that, in the present embodiment, the struts 36 are stepped bolts that can be fastened to the pusher 35 and are inserted in openings formed in the third locator 31C so as to be slidable in the ±X directions.

The pusher 35 is supported on the third locator 31C by the two struts 36 that are arranged in such a manner as to sandwich the entry positions of the cutting blades 41, and the pusher 35 is lightly biased in the −X direction by the springs 37.

The third locator 31C constitutes a lateral wall of the tablet falling path 32 as mentioned above, and in the basic state, a gap L1 between the first locator 31A and the third locator 31C is set to be wider than the width Sx of one of the tablets 10 given beforehand or defined by a setting in an initial state, which will be described later, so that the tablet 10 can fall.

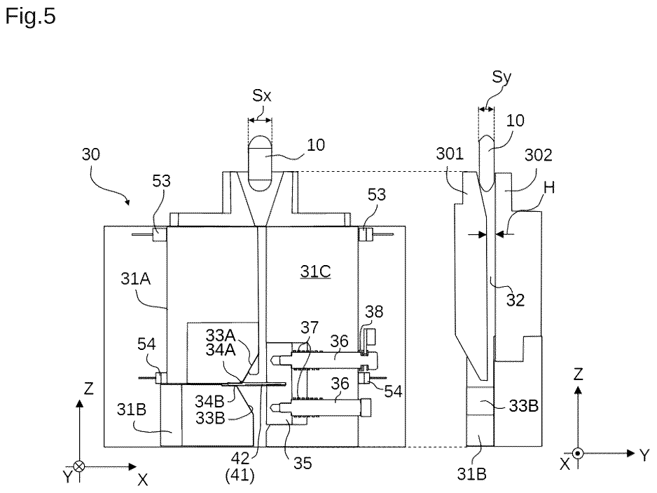

FIG. 5 illustrates a state in which the first locator 31A, the second locator 31B, and the third locator 31C are in their most compact arrangement with respect to each other, that is, in a closed state, when one of the tablets 10 flows into the upstream-portion path 32a of the tablet falling path 32 and is halted mid-way along the tablet falling path 32. FIG. 5 illustrates this state in order to illustrate an operation that is performed during the period from when the tablet 10 falls until the control unit 23 calculates, in accordance with the tablet 10, the gap Ll between the first locator 31A and the third locator 31C in the basic state. This state will be referred to as an initial state.

FIG. 5 includes another diagram on the right-hand side thereof illustrating a sectional view in the vertical direction, that is, a YZ sectional view, in the same state. In this diagram, a distance H in the Y direction can be adjusted in accordance with the height of each tablet 10 and is at its narrowest in the closed state, which is the initial state. In such a state, the tablet 10 discharged from the cassette 21 is stopped and retained at the upstream-portion path 32a. In the actual operation stage of the retaining mechanism 30, which will be described later, it is preferable that the control unit 23 adjust the gap between the ceiling member 301 and the base member 302 by using data regarding the dimensions of the tablet 10 so as to perform height control. However, combinations of a plurality of types of ceiling members 301 and a plurality of types of base members 302 may be predetermined depending on the types of tablets 10, and these members may be suitably replaced. In this case, the distance H is set to be greater than the predetermined height Sy of tablet 10.

The operation of the retaining mechanism 30 and an operation of dividing each tablet 10 performed by the cutting part 40 will now be described with reference to FIG. 5 to FIG. 10.

As illustrated in FIG. 5, when one of the tablets 10 reaches the upstream-portion path 32a, all of the first locator 31A, the second locator 31B, and the third locator 31C are retained in the closed state (initial state) narrowing the tablet falling path 32.

Thus, when the control unit 23 causes the tablets 10 to be discharged one at a time from the tablet cassette 21 (step S101), one of the tablets 10 is stop at the upstream-portion path 32a (step S102).

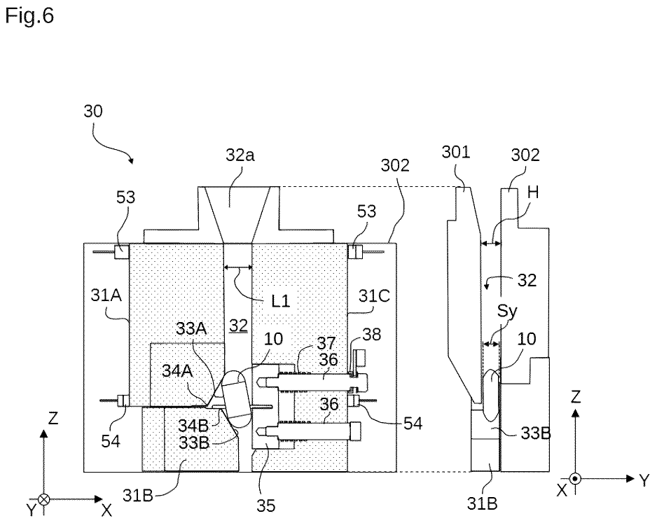

Next, as illustrated in FIG. 6, the ceiling member 301 moves in the Y direction, and the first locator 31A moves in the −X direction so as to increase the width of the tablet falling path 32 (step S103).

In the present embodiment, step S103 is repeated until the upstream fall sensors 53 detect the tablet 10 falling into the tablet falling path 32.

In this case, the control unit 23 drives the ceiling member 301 while measuring the distance H in the Y direction from the position of the ceiling member 301, and when the upstream fall sensors 53 detect the tablet 10 falling into the tablet falling path 32 (step S104), it can detect the ceiling member 301 being located at a position where the distance H and the height Sy of the tablet 10 satisfy HZSy. By storing the distance H in the control unit 23 as the position of the ceiling member 301 at which the tablet 10 can fall, it can also speed up the speed until discharge of the tablet 10. Alternatively, the distance H may be stored as the basic state for discharging the tablet 10.

The tablet 10 falls through the tablet falling path 32 that has been widened by the movements in step S103 until it reaches near the entry positions of the cutting blades 41, that is, the gap portions 42. Note that, at this point in time, the second locator 31B remains in the initial state and has not moved, and thus, the tablet 10 is stopped and retained at an upper portion of the second locator 31B in the basic state (step S105).

Regarding falling of each tablet 10 in this case, for example, as illustrated in FIG. 6, although it depends on the shape of each of the tablets 10 or the way in which each tablet 10 moves from the tablet cassette 21, the tablets 10 often fall in a state of being inclined with respect to a direction in which the tablet falling path 32 extends.

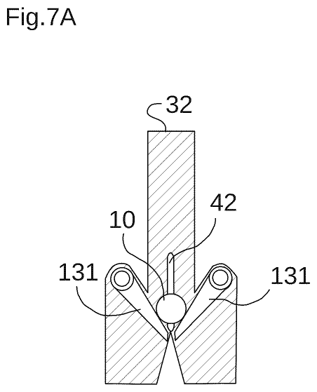

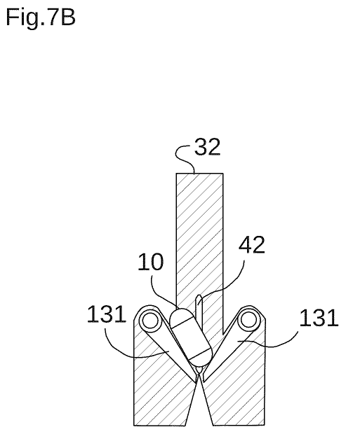

In the related art, in the case where each of the tablets 10 has a relatively simple shape, such as a circular shape or a lens-like shape, as illustrated in FIG. 7A as a comparative example, by using retaining members 131 that are arranged in a V-shape such that the tablet falling path 32 becomes narrower toward a downstream side, the positions of the gap portions 42 at the center of the tablet falling path 32 may be aligned with the center position of each tablet 10, so that it is relatively easy to divide each of the tablets 10 at the center of the tablet 10 into two equal pieces.

However, like the tablet 10 that has an oval-shaped, spherical appearance and that is illustrated in FIG. 7B illustrating the same comparative example, there are tablets that cannot be divided into two equal pieces due to their shapes, and there has been a demand for a tablet dividing apparatus that has higher versatility and that is capable of handling various shapes with a simple configuration.

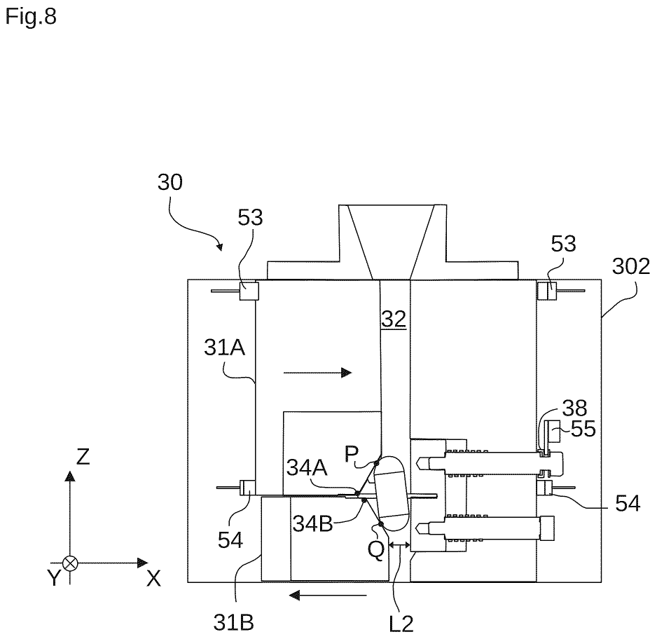

As illustrated in FIG. 8, the control unit 23 gradually moves the first locator 31A in the +X direction and gradually moves the second locator 31B in the −X direction with respect to the tablet 10 that has fallen in an inclined manner (step S106). In this manner, the first locator 31A and the second locator 31B move in parallel but in opposite directions.

Ideally, when a gap L2 between the second locator 31B and the third locator 31C becomes equal to the width Sx of the tablet 10, the tablet 10 passes through the tablet falling path 32 and starts to fall again.

However, a general tablet 10 has a curved shape with a curvature R at both front and rear end portions thereof in its falling direction.

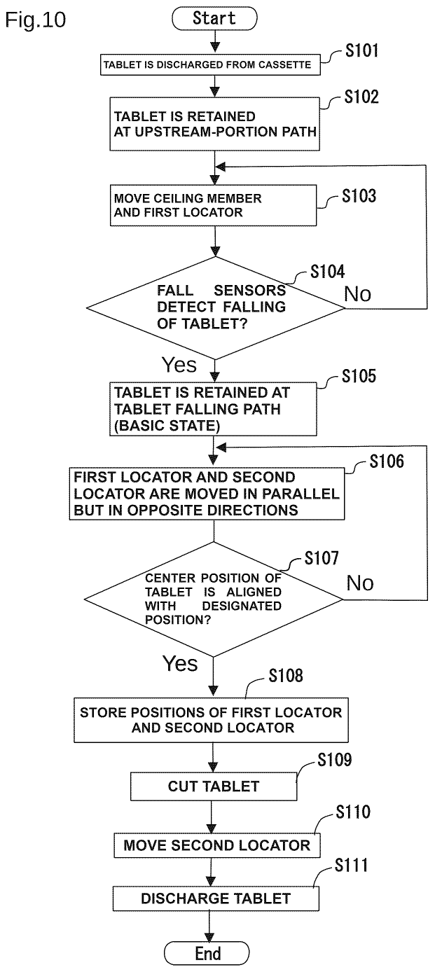

Since the first locator 31A moves in the +X direction and the second locator 31B moves in the −X direction, a contact position P between the rear-end inclined portion 33A and the tablet 10 and a contact position Q between the front-end inclined portion 33B and the tablet 10 gradually change and move due to the curvatures R of the tablet 10 or the inclination of the tablet 10, bringing the tablet 10 into an upright position. Although the contact positions P and Q in this case basically differ depending on the shape of each tablet 10, the rear-end inclined portion 33A and the front-end inclined portion 33B each have a shape that is line-symmetric with respect to the entry positions of the cutting blades 41, and thus, when the tablet 10 is an upright position with respect to its falling direction as illustrated in FIG. 10, the contact position P and the contact position Q are also geometrically symmetrical with respect to the entry positions of the cutting blades 41. In other words, the entry positions of the cutting blades 41 are substantially aligned with the center position of the tablet 10. Here, the term “substantially aligned” refers to the case where the components, quantities, and the like of upper and lower halves of the tablet 10 that is cut in halves at the entry positions are matched to the extent that they do not affect a prescribed dosage and may include the case of not being “equal” in a strict sense.

Although the case where the entry positions of the cutting blades 41 are not aligned precisely with the center position of the tablet 10 is included because the gap portions 42 where the cutting blades 41 enter each have a reasonable width, the state in which the tablet 10 is retained in an upright position in the direction in which the tablet falling path 32 extends corresponds to the state in which the center position of the tablet 10 is aligned with the gap portions 42 and thus the entry positions of the cutting blades 41.

When the tablet 10 is in an upright position in the direction in which the tablet falling path 32 extends, it is estimated that the gap L2 between the second locator 31B and the third locator 31C is narrower than the width Sx of the tablet 10. How narrow the gap L2 is depends on the inclination angle of the front-end inclined portion 33B and the curvatures R of the curved shape of the tablet 10. In addition, since the first locator 31A has moved in the +X direction, and the rear-end inclined portion 33A is in contact with the rear-end inclined portion 33A at this point in time, the lowest point (Xa, Ya) of the rear-end inclined portion 33A and the highest point (Xb, Yb) of the front-end inclined portion 33B are located at positions overlapping each other in the X direction.

In other words, when the lowest point of the rear-end inclined portion 33A is defined as a reference point A (Xa, Ya) and the highest point of the front-end inclined portion 33B is defined as a reference point B (Xb, Yb), the tablet 10 is retained in an upright position with respect to the tablet falling path 32 at a position where Xa=Xb is satisfied. This position of the tablet 10 corresponds to the “designated position”. In this case, it is also estimated that P (Xp, Yp) and Q (Xq, Yq) satisfy Xp=Xq.

Since the rear-end inclined portion 33A and the front-end inclined portion 33B have the same inclination angle, when the entry positions of the cutting blades 41 are each at the center between the first locator 31A and the second locator 31B, the cutting blades 41 occupy the position of the perpendicular bisector of a line segment PQ, so that the tablet 10 can be divided into two equal pieces.

Such an operation, performed by the retaining mechanism 30, of aligning the center position of each tablet 10 with the positions of the openings of the gap portions 42 by using the first locator 31A and the second locator 31B will be referred to as the centering operation.

The control unit 23 calculates moving distances of the first and second locators 31A and 31B by using, for example, the rotational speeds of motors that drive the first and second locators 31A and 31B and determines that the center position of the tablet 10 is aligned with the designated positions on the condition that the first locator 31A and the second locator 31B are aligned with each other in their respective moving directions (step S107). In step S107, which is such a determination step, the control unit 23 gradually moves the first locator 31A and the second locator 31B by repeating step S106, while the retaining mechanism 30 operates as retaining means for aligning the center position of the tablet with the entry positions of the cutting blades 41.

The control unit 23 gradually repeats the movement in step S106 until the center position of the tablet 10 becomes aligned with the designated position in step S107.

Note that, the control unit 23 operates as the center-position determination means while using alignment of the first locator 31A and the second locator 31B as a condition under which it determines that the center position of the tablet 10 is aligned with the designated position. However, the reference points used for the condition may be, for example, the positions of wall surfaces facing the tablet falling path 32, and alignment of the lateral surface of the first locator 31A facing the tablet falling path 32 and the lateral surface of the second locator 31B facing the tablet falling path 32 may be used. Alternatively, when the lowest point of the rear-end inclined portion 33A and the highest point of the front-end inclined portion 33B are respectively defined as a reference point A (Xa, Ya) and a reference point B (Xb, Yb), the position where Xa=Xb is satisfied may be detected by the control unit 23.

However, even if a servo motor is used as a driving source, for example, such position adjustment may involve some errors because the first locator 31A and the second locator 31B are driven independently. In addition, in order to improve the accuracy, it is important not only to calculate the moving distances by using the rotational speeds of the motors, but also to comprehend the state in which the first locator 31A and the second locator 31B are actually operating.

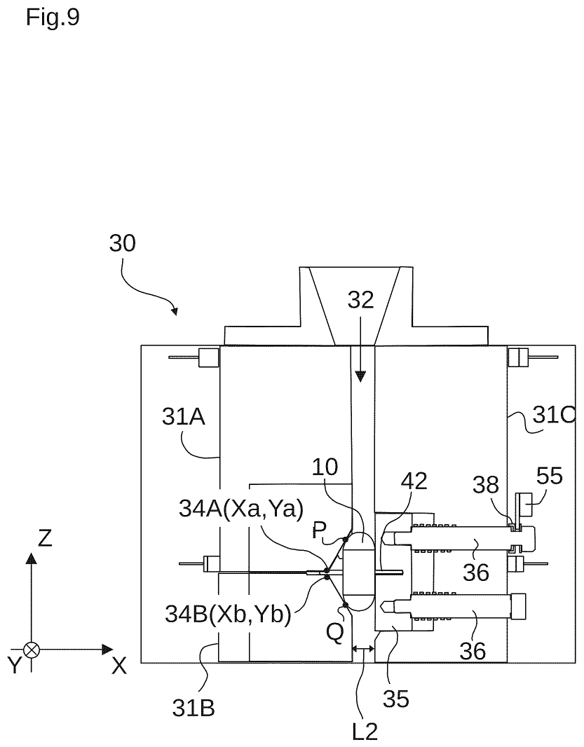

Accordingly, in the present embodiment, in order to further improve the accuracy, the pusher 35 is caused by the springs 37 to lightly bias each tablet 10 in the −X direction, which is the leftward direction in FIG. 9. When the pusher 35 is equally pushed upward and downward by the first locator 31A and the second locator 31B via one of the tablets 10, the pusher 35 retreats loosely enough to interrupt the electrical continuity between the contact ring 38 and the struts 36, and the contact ring 38 detects the movement of the pusher 35.

Here, since the pusher 35 is fitted in the third locator 31C, when a horizontal force acts on the pusher 35 in the X direction in which the struts 36 extend, the pusher 35 retreats slightly. However, when the tablet 10 is not in an upright position and is unevenly pushed due to uneven transmission of the force, the pusher 35 does not move, and thus, it does not interrupt the electrical continuity between the struts 36 and the contact ring 38.

As described above, by using the contact ring 38, the tablet 10 is reliably determined to be in an upright position in the tablet falling path 32 when the pusher 35 is pushed, and the electrical continuity between the struts 36 and the contact ring 38 is interrupted, so that the control unit 23 can accurately detect that the tablet 10 is retained at the designated position.

Note that, in the above configuration, another sensor or control means may be used instead of the contact ring 38 as long as the retreat of the pusher 35 can be detected. In the present embodiment, the contact ring 38 is used as particularly inexpensive means for allowing the control unit 23 to easily detect interruption of electrical continuity.

Note that, in step S107, the control unit 23 may combine these plurality of means so as to determine that, for example, the positions of the inflection points 34A and 34B, which are the reference points, overlap each other in the X direction, and in addition, may detect that the electrical continuity has been interrupted by using the contact ring 38. The control unit 23 may determine that the tablet 10 is retained at the designated positions only when both results are true.

The control unit 23 stores beforehand the amount of movement of the first locator 31A and the amount of movement of the second locator 31B during the period from when one of the tablets 10 falls until the tablet 10 is retained at the designated position and stores them in storage means together with drug information of the tablet 10 read from an RFID or the like of the tablet cassette 21 (step S108). As described above, even if there is no data regarding the dimensions of the tablet 10, the center position of the tablet 10 can be calculated in the present embodiment, and in addition, the combination of the type of the tablet 10 and the moving distances of the first and second locators 31A and 31B can be stored by performing these operations. Thus, in the second and subsequent operations, it may be operated at high speed up to around the already determined moving distance, and the time taken for the tablet 10 to be retained at the designated position can be reduced.

When the tablet 10 is retained at the designated position in this manner, the cutting blades 41 enter the tablet 10 from the two sides of the tablet 10, that is, from the two sides in the ±Y directions in the present embodiment, and the tablet 10 retained at the designated position is cut in halves (step S109). In the cutting step, which is step S109, the cutting part 40 or each of the cutting blades 41 operates as tablet cutting means.

In the cutting step, the cutting blades 41, which are arranged so as to face each other, move so as to clamp and cut the tablet 10 while reducing the gap between them and comes into contact with the tablet 10. In this case, before completion of the cutting, it is preferable that the cutting blades 41 retain the tablet 10 in a state where the tablet 10 is not in contact with either the base member 302, which is a bottom portion of the tablet falling path 32, or the ceiling member 301. In addition, it is preferable that the first locator 31A and the second locator 31B slightly move in a direction in which the tablet falling path 32 expands, that is, in the −X direction, under control of the control unit 23 and that the tablet 10 be clamped only by the cutting blades 41 during the period from when the cutting blades 41 clamp the tablet 10 until the cutting is completed. In this case, the third locator 31C may move in the +X direction.

Since the temporary retaining of the tablet 10 by the first locator 31A, the second locator 31B, and the third locator 31C is released immediately before the cutting is completed in the cutting step as described above, the tablet 10 is clamped only by the cutting blades 41 before completion of the cutting, and even when a strong force is temporarily applied to the tablet 10 during the cutting, the center position will not be shifted, so that accurate halving can be performed. Note that the tablet 10 can be cut without releasing the temporary retaining of the tablet 10 by the first locator 31A, the second locator 31B, and the third locator 31C, and fine control and movement during the cutting are not limited to the above configuration.

After the tablet 10 has been cut in halves, only the second locator 31B is further moved in the −X direction while the cutting blades 41 remain in a state of blocking the tablet falling path 32 (step S110). Note that, although the second locator 31B is moved also during the cutting step of cutting the tablet 10 as described above, in step S110, the second locator 31B continues to move until the gap L2 between the second locator 31B and the third locator 31C becomes equal to or greater than the width Sx of the tablet 10 so as to allow the lower piece of the halved tablet 10 to fall downward, and these may be performed in reverse order. More specifically, if the movement of the second locator 31B in step S110 has already been completed in a state where the tablet 10 is clamped between the cutting blades 41 before the cutting is performed in step S109, the lower piece simply falls and is discharged at the same time as the cutting step S109 is completed, and the process proceeds to step S111.

When the gap L2 between the second locator 31B and the third locator 31C becomes equal to or greater than the width Sx of the tablet 10, the tablet 10 that have lost their support falls downward along the tablet falling path 32 and is discharged (step S111).

In this case, the control unit 23 may cause the moving distance of the second locator 31B to move in accordance with the tablet width Sx, or conversely, a fall sensor 56 (not illustrated) may be provided below the second locator 31B in the tablet falling path 32, and the gap L2 at which falling of the tablet 10 is detected by the fall sensor 56 may be stored as the tablet width. In any case, after completion of the cutting step, when the gap L2, which is the width of the tablet falling path 32 between the second locator 31B and the third locator 31C, becomes equal to or larger than the tablet width Sx, the lower half of the tablet 10 is discharged from the retaining mechanism 30.

When a certain period of time has elapsed since the second locator 31B has been moved, the control unit 23 causes the cutting blades 41 to retreat and causes the first locator 31A to move such that the upper half of the tablet 10 is discharged from the retaining mechanism 30.

When both of the two equally divided pieces of the tablet 10 are discharged, the control unit 23 causes the second locator 31B to move in the +X direction and then stop at a position where the tablet falling path 32 is narrower than the stored tablet width Sx and waits for the next discharge from the tablet cassette 21.

By repeating the operations in steps S101 to S111, the tablet dividing apparatus 20 can halve each of the tablets 10 discharged from the tablet cassette 21.

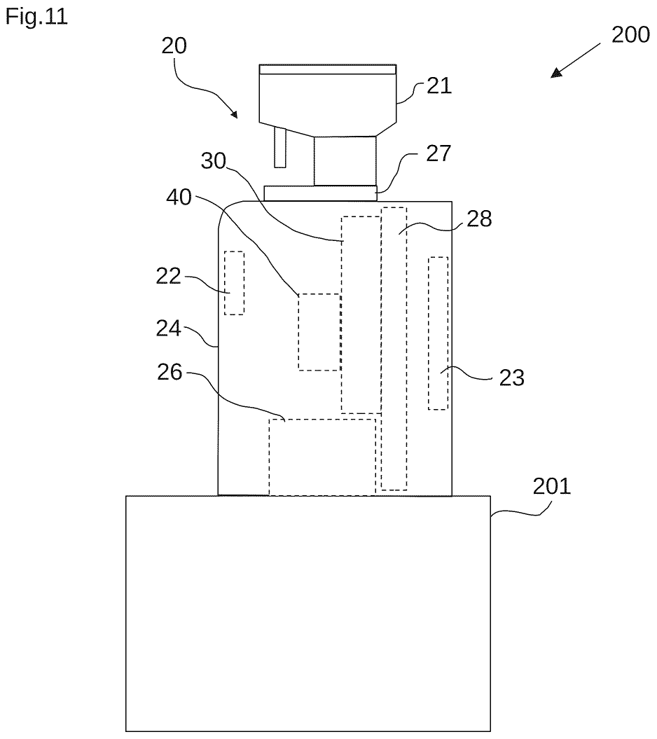

As a second embodiment of the present embodiment, as illustrated in FIG. 11, a tablet packing machine 200 that has a configuration in which a packaging machine 201 is provided so as to be located further downstream along the tablet falling path 32 than the tablet dividing apparatus 20 in the first embodiment and that packs the tablets 10 each of which has been halved may be considered.

The configuration of the packaging machine 201 having such a configuration may be the same as that of a known apparatus, and thus, the description thereof will be omitted.

In the present embodiment, the upper and lower pieces of the tablets 10 that have fallen through the tablet falling path 32 each pass through the relay portion 26. Then, they are packaged with packaging paper by the packaging machine 201 and discharged.

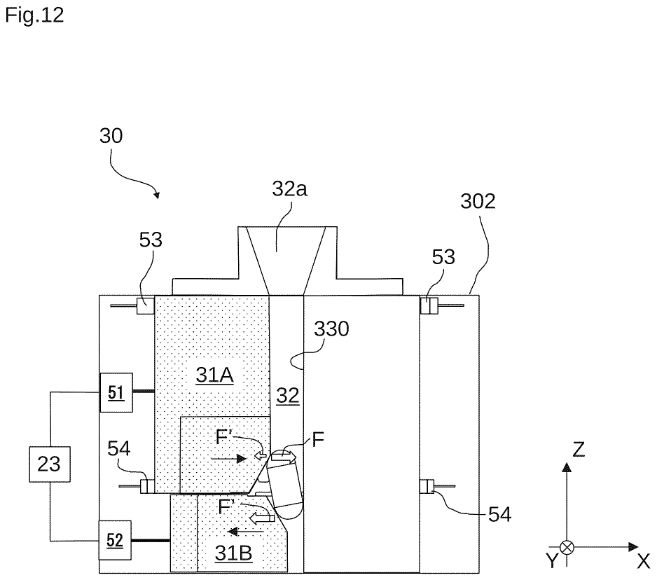

As a third embodiment of the present invention, a case will be described in which a wall surface of the tablet falling path 32 that is simply fixed in place is provided instead of the third locator 31C, which is the third movable member, as illustrated in FIG. 12.

Note that, also in the present embodiment, components that have been already described in the first embodiment are denoted by the same reference signs, and descriptions thereof will be omitted.

In the third embodiment, as illustrated in FIG. 12, the first locator 31A and the second locator 31B are provided, and a first motor 51 and a second motor 52 that are drive sources respectively connected to the first locator 31A and the second locator 31B are provided.

The first motor 51 is a servo motor and also functions as pressure sensing means that is capable of detecting, by detecting a load generated when the first locator 31A is driven, a pressure with which the first locator 31A is pressed by each tablet 10.

Note that, for example, the control unit 23 may have the configuration as a control mechanism for the first motor 51.

Similar to the first motor 51, the second motor 52 is a servo motor and also functions as pressure sensing means that is capable of detecting, by detecting a load generated when the second locator 31B is driven, a pressure with which the second locator 31B is pressed by each tablet 10.

Note that, for example, the control unit 23 may have the configuration as a control mechanism for the second motor 52.

When one of the tablets 10 have fallen into the tablet falling path 32, the retaining mechanism 30 performs operations similar to those in steps S101 to S105 illustrated in FIG. 10, and the control unit 23 arranges the first locator 31A and the second locator 31B in the basic state. FIG. 12 illustrates the state of the tablet 10 in the basic state.

Next, as in step S106, the second locator 31B is moved in the −X direction, and the first locator 31A is moved in the +X direction.

In this case, the control unit 23 determines that the center position of the tablet 10 is aligned with the designated position on the condition that the load on the first motor 51 and the load on the second motor 52 are equal to each other (step S107).

In step S107, the tablet 10 is pushed by the first locator 31A and the second locator 31B toward a wall surface 330 that is the wall surface of the tablet falling path 32 facing the first and second locators 31A and 31B with a force F illustrated in FIG. 12, and thus, the first locator 31A receives a force F′ in the −X direction from the tablet 10 as a reaction. In the state in which the tablet 10 is inclined with respect to the tablet falling path 32, the load applied to the first locator 31A and the load applied to the second locator 31B are not expected to be equal to each other as schematically illustrated in FIG. 12.

In addition, the load applied to the second locator 31B is a load generated in the −X direction due to contact between the tablet 10 and the front-end inclined portion 33B, and this load is presumed to be zero when the second locator 31B and the tablet 10 are separated from each other and is presumed to become the largest in a state where the tablet 10 is not clamped between the first locator 31A and the wall surface 330, that is, in a state where the tablet 10 starts to move.

Assume the case where the pressure F′ applied to the first locator 31A and the pressure F′ applied to the second locator 31B are equal to each other.

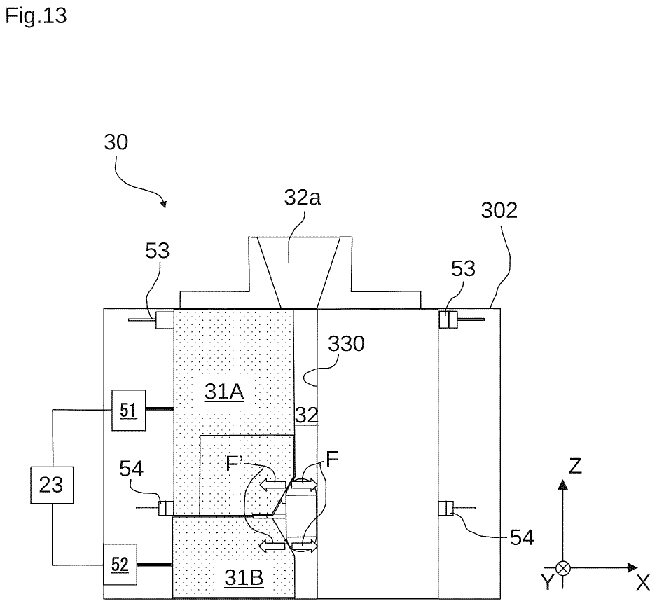

In this case, the first locator 31A and the second locator 31B push the tablet 10 uniformly, and thus, in the case of using the first locator 31A and the second locator 31B each having a shape that is line-symmetric with respect to a retaining position as illustrated in FIG. 13, it may be presumed that the tablet 10 is retained in a symmetrical state with respect to the retaining position.

Note that, after the tablet 10 has been retained at the retaining position, as in the first embodiment, a process is performed as in steps S108 to S111 such that the tablet 10 is cut in halves, and that the pieces of the tablet 10 are each discharged through the tablet falling path 32.

With the above-described configuration, the control unit 23 uses the first motor 51 and the second motor 52 so as to determine that the center position of each tablet 10 is aligned with the designated position on the condition that the pressure applied to the first locator 31A by the tablet 10 and the pressure applied to the second locator 31B by the tablet 10 are equal to each other.

According to the configuration, since the control unit 23 can detect each tablet 10 being in an upright position with respect to the tablet falling path 32, the retaining mechanism 30 can retain each tablet 10 such that the center position of the tablet 10 and the entry positions of the cutting blades 41 are aligned with each other and can perform alignment of the center position of the tablet and the cutting part with a simple configuration. Therefore, the tablet dividing apparatus 20 can handle tablets having various shapes.

In addition, as described in the first embodiment, it is desirable that the rear-end inclined portion 33A of the first locator 31A and the front-end inclined portion 33B of the second locator 31B respectively come into contact with the front end portion and the rear end portion of each tablet 10. However, if a degree of inclination is too steep with respect to the length Sz of the tablet 10, the front end portion and the rear end portion of the tablet 10 may not appropriately come into contact with the rear-end inclined portion 33A and the front-end inclined portion 33B, respectively.

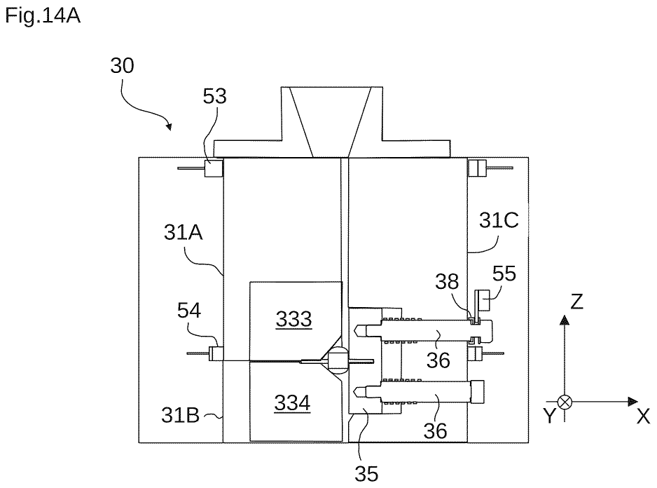

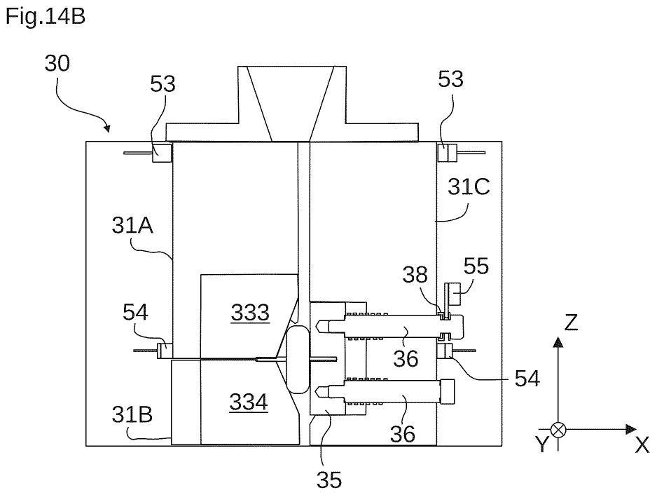

Thus, it is preferable that the degree of inclination of the rear-end inclined portion 33A and the degree of inclination of the front-end inclined portion 33B can be changed in accordance with an approximate length of each tablet 10 as illustrated in FIG. 14A and FIG. 14B. For example, a locator guide portion 333 and a locator guide portion 334 that respectively constitute the rear-end inclined portion 33A of the first locator 31A and the front-end inclined portion 33B of the second locator 31B can be replaced with a plurality of types such that the inclination angles of the rear-end inclined portion 33A and the front-end inclined portion 33B are reduced when the length Sz of the tablet 10 is large and such that the inclination angles of the rear-end inclined portion 33A and the front-end inclined portion 33B are increased when the length Sz of the tablet 10 is small.

With the configuration, for a wider variety of tablets 10, the retaining mechanism 30 can retain each tablet 10 such that the center position of the tablet 10 and the entry positions of the cutting blades 41 are aligned with each other and can perform alignment of the center position of the tablet and the cutting part with a simple configuration.

### 1

The tablet dividing apparatus 20 of the present invention includes a retaining mechanism 30 that is disposed midway along a tablet falling path 32 of tablets 10 for retaining each of the tablets 10 at a designated position, a cutting part 40 that includes cutting blades 41 capable of cutting each of the tablets 10 by moving into and out of the falling path 32, and a control unit 23 for aligning the center position of each of the tablets 10 with entry positions of the cutting blades 41.

The retaining mechanism 30 includes a first locator 31A that is located above the entry positions, that forms a lateral surface of the tablet falling path 32, and that is capable of moving in a direction perpendicular to the tablet falling path 32, and a second locator 31B that is positioned below the entry positions in such a manner as to narrow the tablet falling path 32 and that is capable of moving in a direction parallel to, but opposite to, the first locator 31A.

The control unit 23 determines that the center position of each of the tablets 10 is aligned with the designated position on the condition that the first locator 31A and the second locator 31B are aligned with each other in their moving directions.

According to the configuration, since the control unit 23 can detect each tablet 10 being in an upright position with respect to the tablet falling path 32, the retaining mechanism 30 can retain each tablet 10 such that the center position of the tablet 10 and the entry positions of the cutting blades 41 are aligned with each other and can perform alignment of the center position of the tablet and the cutting part with a simple configuration. Therefore, the tablet dividing apparatus 20 can handle tablets having various shapes.

### 2

In addition to the configuration described in <1>, in the embodiments of the present invention, the control unit 23 determines that the center position of each tablet 10 is aligned with the designated position on the condition that the pressure applied to the first locator 31A by the tablet 10 and the pressure applied to the second locator 31B by the tablet 10 are equal to each other.

According to the configuration, since the control unit 23 can detect each tablet 10 being in an upright position with respect to the tablet falling path 32, the retaining mechanism 30 can retain each tablet 10 such that the center position of the tablet 10 and the entry positions of the cutting blades 41 are aligned with each other and can perform alignment of the center position of the tablet and the cutting part with a simple configuration. Therefore, the tablet dividing apparatus 20 can handle tablets having various shapes.

### 3

In addition to the configuration described in <1 > or <2 >, in the embodiments of the present invention, the tablet dividing apparatus 20 includes the third locator 31C that faces the first locator 31A and the second locator 31B and that constitutes a portion of the tablet falling path 32.

The third locator 31C includes the pusher 35 that pushes each of the tablets 10 against the first locator 31A and the second locator 31B.

### 4

In addition to the configuration described in any one of <1 > to <3 > , in the embodiments of the present invention, the pusher 35 is connected to the third locator 31C by the two struts 36 that are arranged in such a manner as to sandwich the entry positions, and the contact ring 38 that is attached to at least one of the struts 36 and that detects movement of the pusher 35 is provided. In addition, the control unit 23 determines that the center position of the tablet 10 is aligned with the designated position upon movement of the pusher 35.

According to the configuration, since the control unit 23 can detect each tablet 10 being in an upright position with respect to the tablet falling path 32, the retaining mechanism 30 can retain each tablet 10 such that the center position of the tablet 10 and the entry positions of the cutting blades 41 are aligned with each other and can perform alignment of the center position of the tablet and the cutting part with a simple configuration. Therefore, the tablet dividing apparatus 20 can handle tablets having various shapes.

### 5

In addition to the configuration described in any one of <1> to <4>, in the embodiments of the present invention, the first locator 31A includes the rear-end inclined portion 33A as an inclined portion that is inclined with respect to the tablet falling path 32, and the second locator 31B includes the front-end inclined portion 33B as an inclined portion that is inclined with respect to the tablet falling path 32.

The front-end inclined portion 33B comes into contact with the front end portion of each tablet 10, and the rear-end inclined portion 33A comes into contact with the rear end portion of each tablet 10, so that the retaining mechanism 30 can retain the tablet 10 such that the center position of the tablet 10 is aligned with the designated position.

Note that the term “front end portion” of the table 10 may include the front end in the length direction of the tablet 10 and a portion having a curved shape with a curvature in the same direction. Similarly, the term “rear end portion” of the table 10 may include the rear end in the length direction of the tablet 10 and a portion having a curved shape with a curvature in the same direction.

### 6

In addition to the configuration described in any one of <1> to <5>, in the embodiments of the present invention, in the tablet dividing apparatus 20, the first locator 31A and the second locator B move in opposite directions relative to each other, and the retaining mechanism 30 retains each tablet 10 at a position where the lowest end point of the rear-end inclined portion 33A of the first locator 31A and the highest end point of the front-end inclined portion 33B of the second locator 31B overlap with each other in the moving directions.

According to the configuration, since the control unit 23 can detect each tablet 10 being in an upright position with respect to the tablet falling path 32 and being held symmetrically with the entry positions of the cutting blades 41, alignment of the center position of the tablet and the cutting part can be performed with a simple configuration.

Therefore, the tablet dividing apparatus 20 can handle tablets having various shapes.

### 7

In addition to the configuration described in any one of <1> to <6>, in the embodiments of the present invention, in the tablet dividing apparatus 20, the cutting part 40 enters the tablet falling path 32 and cuts each tablet 10 after the control unit 23 has determined that the center position of the tablet 10 is aligned with the designated position.

According to the configuration, each tablet 10 can be divided along a plane that passes through the center position of the tablet 10, and halving of the tablet 10 can be accurately performed with a simple configuration.

### 8

In addition to the configuration described in <7>, in the embodiments of the present invention, the packing machine 200 includes the tablet dividing apparatus 20 and the packaging machine 201 provided so as to be located further downstream along the tablet falling path 32 than the tablet dividing apparatus 20 and is configured to pack the tablets 10 each of which has been halved.

According to the configuration, the tablets 10 each of which has been halved can be packed.

### Others

In the above-described embodiments, only the configuration has been described in which the cutting blades 41 cut each tablet 10 by clamping the tablet 10 from the upper and lower sides of the tablet falling path 32.

However, for example, the cutting blades 41 may be inserted between the first locator 31A and the second locator 31B and removed therefrom, or a cutting blade may be inserted from only one side and removed to cut the tablet 10.

### REFERENCE SIGNS LIST

10 tablet
20 tablet dividing apparatus
23 control unit (center-position determination means)
30 retention part
31A first locator (first movable member)
31B second locator (second movable member)
31C third locator (third movable member)
32 falling path
33A, 33B inclined portion
34A, 34B reference point
35 pusher (pushing unit)
38 contact ring (sensing means)
40, 41 cutting part (cutting means)
42 gap portion (entry position)
200 tablet packing machine
S107 determination step
S109 cutting step

1. A tablet dividing apparatus comprising:
a retention part disposed midway along a falling path of a tablet for retaining the tablet at a designated position;
a cutting part that includes a blade capable of cutting the tablet by moving into and out of the falling path; and
center-position determination means for aligning a center position of the tablet with an entry position of the cutting part,
wherein the retention part includes
a first movable member that is located above the entry position, that forms a lateral surface of the falling path, and that is capable of moving in a direction perpendicular to the falling path, and
a second movable member that is positioned below the entry position in such a manner as to narrow the falling path and that is capable of moving in a direction parallel to, but opposite to, the first movable member, and
wherein the center-position determination means determines that the center position of the tablet is aligned with the designated position on a condition that the first movable member and the second movable member are aligned with each other in a moving direction of the first movable member and a moving direction of the second movable member.

2. The tablet dividing apparatus according to claim 1,
wherein the center-position determination means determines that the center position of the tablet is aligned with the designated position on a condition that a pressure applied to the first movable member by the tablet and a pressure applied to the second movable member by the tablet are equal to each other.

3. The tablet dividing apparatus according to claim 1, further comprising:
a third movable member that faces the first movable member and the second movable member and that constitutes a portion of the falling path,
wherein the third movable member includes a pushing unit that pushes the tablet against the first movable member and the second movable member.

4. The tablet dividing apparatus according to claim 3,
wherein the pushing unit is connected to the third movable member by two struts that are arranged in such a manner as to sandwich the entry position,
wherein the tablet dividing apparatus includes sensing means for detecting movement of the pushing unit, the sensing means being attached to at least one of the struts, and
wherein the center-position determination means determines that the center position of the tablet is aligned with the designated position upon movement of the pushing unit.

5. The tablet dividing apparatus according to claim 1,
wherein the first movable member and the second movable member each include an inclined portion that is inclined with respect to the falling path, and
wherein one of the inclined portions retains the tablet by coming into contact with a front end portion of the tablet, and another one of the inclined portions retains the tablet by coming into contact with a rear end portion of the tablet such that the center position of the tablet is aligned with the designated position.

6. The tablet dividing apparatus according to claim 5,
wherein the first movable member and the second movable member move in opposite directions relative to each other, and
wherein the retention part retains the tablet at a position where the lowest end point of the inclined portion of the first movable member and the highest end point of the inclined portion of the second movable member overlap with each other in the moving directions.

7. The tablet dividing apparatus according to claim 1,
wherein the cutting part enters the falling path and cuts the tablet after the center-position determination means has determined that the center position of the tablet is aligned with the designated position.

8. A tablet packing machine comprising the tablet dividing apparatus according to claim 7.

9. A tablet dividing method that is performed by using
retaining means for retaining a tablet at a designated position, the retaining means being disposed midway along a falling path of the tablet,
tablet cutting means for cutting the tablet by moving into and out of the falling path, and
center-position determination means for aligning a center position of the tablet with an entry position of the tablet cutting means,
wherein the retaining means controls
a first movable member that is located above the entry position, that forms a lateral surface of the falling path, and that is capable of moving in a direction perpendicular to the falling path, and
a second movable member that is positioned below the entry position in such a manner as to narrow the falling path and that is capable of moving in a direction parallel to, but opposite to, the first movable member,
wherein the tablet dividing method executes
a step of moving the first movable member toward a wall surface of the falling path, the wall surface facing the first movable member, when the tablet moves to a position where the tablet is in contact with the second movable member,
a step of moving the second movable member in a direction away from a wall surface of the falling path, the wall surface facing the second movable member,
a determination step in which the center-position determination means determines that the center position and the entry position are aligned with each other in the step of moving the first movable member and the step of moving the second movable member, and
a cutting step of cutting the tablet by using the tablet cutting means.

10. The tablet dividing apparatus according to claim 2,
wherein the cutting part enters the falling path and cuts the tablet after the center-position determination means has determined that the center position of the tablet is aligned with the designated position.

11. The tablet dividing apparatus according to claim 3,
wherein the cutting part enters the falling path and cuts the tablet after the center-position determination means has determined that the center position of the tablet is aligned with the designated position.

12. The tablet dividing apparatus according to claim 4,
wherein the cutting part enters the falling path and cuts the tablet after the center-position determination means has determined that the center position of the tablet is aligned with the designated position.

13. The tablet dividing apparatus according to claim 5,
wherein the cutting part enters the falling path and cuts the tablet after the center-position determination means has determined that the center position of the tablet is aligned with the designated position.

14. The tablet dividing apparatus according to claim 6,
wherein the cutting part enters the falling path and cuts the tablet after the center-position determination means has determined that the center position of the tablet is aligned with the designated position.
